(19) United States
(12) Patent Application Publication
(10) Pub. No.: US 2016/0332124 A1
(43) Pub. Date: Nov. 17, 2016

(54) HOME SODA MACHINE OPERATING AT LOW PRESSURE

(71) Applicant: SodaStream Industries Ltd., Ben Gurion Airport (IL)

(72) Inventor: Avi COHEN, Jerusalem (IL)

(21) Appl. No.: 15/149,194

(22) Filed: May 9, 2016

Related U.S. Application Data
(60) Provisional application No. 62/161,285, filed on May 14, 2015.

(51) Int. Cl. B01F 3/04; A23L 2/54

(52) U.S. Cl. CPC B01F 3/04794; A23L 2/54; B01F 2003/049; A23V 2002/00

(57) ABSTRACT

A home soda machine to carbonate a liquid within a removable bottle at an operating pressure within said bottle at or below 6 bar to a carbonation level of at least 3.5 g/l. The home soda machine includes a carbonation unit to receive pulsed CO₂ gas at at least 50 bar to provide the CO₂ gas turbulently within a liquid within the removable soda bottle; and an exhaust valve to control an operating pressure of the machine to a maximum of 6 bar.

### CROSS REFERENCE TO RELATED APPLICATIONS

This application claims priority and benefit from U.S. provisional patent application 62/161,285 filed May 14, 2015 which is incorporated herein by reference.

### FIELD OF THE INVENTION

The present invention relates to home soda machines generally and to the operating pressure of such machines in particular.

### BACKGROUND OF THE INVENTION

Conventional carbonation of water involves adding CO₂ to water in a sealed environment. Henry's Law states that at a constant pressure, the amount of a given gas that can dissolve in a given type and volume of liquid is directly proportional to the partial pressure of that gas in equilibrium with that liquid and temperature. Therefore, the higher the pressure of the gas above the liquid (in this case, the water), the greater the CO₂ absorption.

For high carbonation levels, such as 7 g/l to 10 g/l, in a typical home soda machine, the standard pressure level allowed in the bottle is typically set to 8 bar. FIG. 1, to which reference is now made, shows a simplified home carbonation machine with a carbonation head 10 receiving pressurized CO₂, at a high pressure such as 60 bar, from a canister 12 and providing the CO₂, via a tube 13, to a bottle 14. According to Henry's law, the higher the pressure, the higher the carbonation level. It will be appreciated that typical home soda machines attain a high level of carbonation by operating at 8 bar. To ensure this, the machine of FIG. 1 includes an exhaust valve 16 set to 8 bar. Exhaust valve 16 will release pressure once the pressure in bottle 14 is at 8 bar allowing the process to continue at an 8 bar pressure.

As a safety measure, the carbonation machine may also include a safety valve 18 set to a higher pressure, such as 11 bar, which will release only if exhaust valve 16 fails in some way.

In addition, the yield point of the bottle (i.e. the point at which it may start to expand and eventually fail) may be set to a further higher pressure, such as 17 bar. With proper usage, the bottle will not fail under regular operating pressure. However, if the carbonation machine is misused such that safety valve 18 and exhaust valve 16 no longer work, the bottle may fail. For non-dishwasher safe plastic bottles, the yield point may be reduced by subjection of a bottle to a heat source greater than 50 degrees Celsius, such as the temperature that occurs in a dishwasher.

### SUMMARY OF THE PRESENT INVENTION

There is therefore provided, in accordance with a preferred embodiment of the present invention, a home soda machine to carbonate a liquid within a removable bottle at an operating pressure within the bottle at or below 6 bar to a carbonation level of at least 3.5 g/l.

Moreover, in accordance with a preferred embodiment of the present invention, the home soda machine also includes a carbonation unit to receive pulsed CO₂gas at at least 50 bar to provide the CO2 gas turbulently within a liquid within the removable soda bottle and an exhaust valve to control an operating pressure of the machine to a maximum of 6 bar.

Further, in accordance with a preferred embodiment of the present invention, the home soda machine also includes a carbonation tube to provide the pulsed CO₂ gas under a surface of the liquid.

Still further, in accordance with a preferred embodiment of the present invention, the exhaust valve is set to a pressure level retaining a cushion of CO2 gas above the liquid which keeps the liquid from flowing up into the carbonation head with released CO₂ gas.

Additionally, in accordance with a preferred embodiment of the present invention, the exhaust valve is set to 6 bar.

Moreover, in accordance with a preferred embodiment of the present invention, the yield point of the removable bottle is less than 16 bar.

Further, in accordance with a preferred embodiment of the present invention, the bottle is manufactured from glass or plastic.

There is therefore provided, in accordance with a preferred embodiment of the present invention, a method for a home soda machine. The method includes using turbulence to mix CO₂ gas under a surface of a liquid in a removable home soda bottle, the turbulence caused by CO₂ gas of at least 50 bar moving through a small orifice and controlling an operating pressure of the machine to a maximum of 6 bar.

Moreover, in accordance with a preferred embodiment of the present invention, the method also includes providing the CO₂gas via a carbonation tube.

Further, in accordance with a preferred embodiment of the present invention, the controlling includes modulating carbonation pulses of the CO₂gas into the liquid to prevent the liquid from flowing up into the carbonation head with released CO₂ gas.

Still further, in accordance with a preferred embodiment of the present invention, operating pressure is set to 6 bar.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a prior art home soda machine;

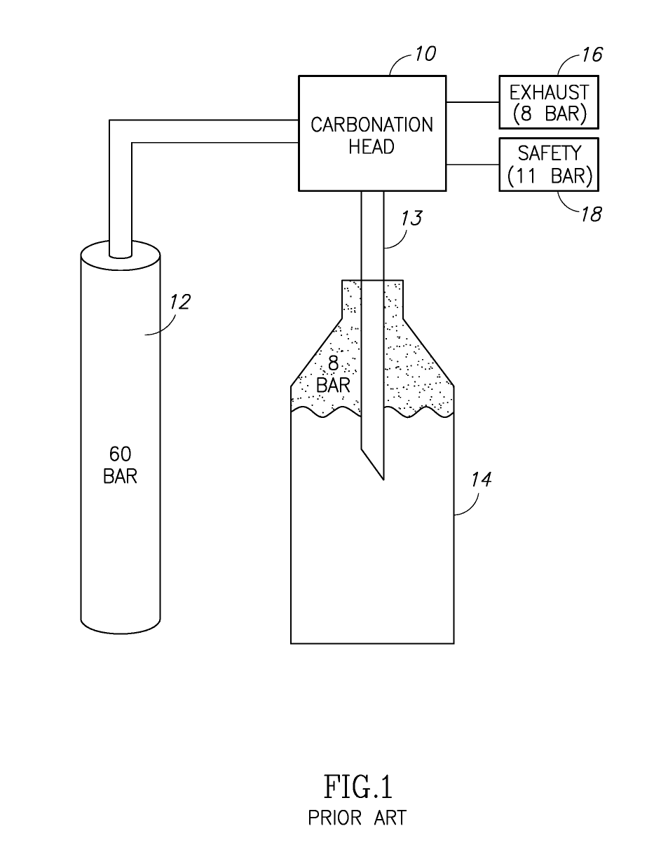

FIG. 2 is a schematic illustration of a low pressure, home soda machine, constructed and operative in accordance with a preferred embodiment of the present invention;

FIGS. 3A and 3B are timing diagram of two alternative automated carbonation cycles, useful in the machine of FIG. 2;

FIG. 4 is a graphical illustration of the efficiency of the absorption of CO₂ as a function of temperature for a number of bottles;

FIG. 5 is a schematic illustration showing stresses in a thin walled pressure vessel; and

FIG. 6 is a graphical illustration of fatigue stress (endurance) versus number of fatigue cycles for 5 different types of plastics.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that Henry's law is true only for pressurized gases which are kept above a liquid for a long period of time, enough time to enable the gas to dissolve into the volume of liquid. However, as Applicant has realized, this is not what happens in home bottle carbonation machines, which carbonate by injecting pressurized CO₂ gas directly into a liquid in the bottle. As Applicant has realized, such machines provide CO₂ at a high pressure, such as 60 bar, which is pulsed until the pressure in the bottle increases to a maximum allowed pressure, such as 8 bar.

Moreover, Applicant has realized that, in these machines, the carbonation head does not provide the gas on top of the water but generally provides it, via the tube, within the water, causing turbulence in the water as it exits. Thus, the gas above the liquid is not in equilibrium with the gas dissolved in the water and therefore, Henry's law does not apply.

Applicant has realized that, as a result of the turbulence, significantly lower pressure levels may be utilized to achieve the same desired carbonation level than have been utilized in the past. Furthermore, the amount of energy in an explosion of a bottle, which is a significant concern, is a function of the pressure and thus, the lower the pressure, the significantly lower the energy of explosion. In other words, the soda machine and the bottle both become much safer.

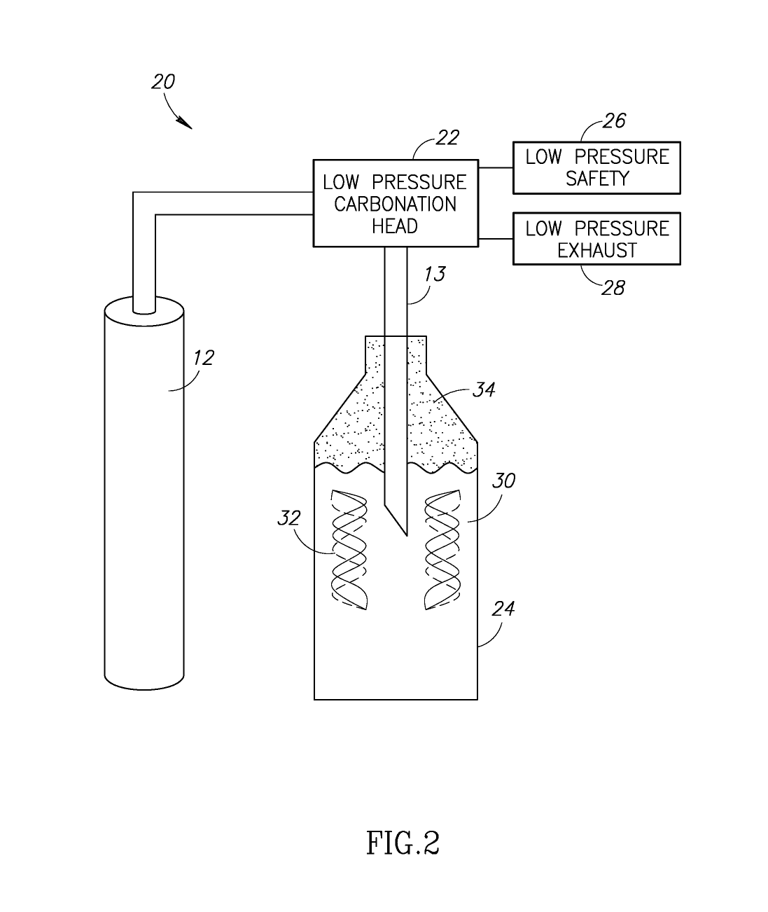

Reference is now made to FIG. 2, which illustrates a low pressure, home soda machine 20, constructed and operative in accordance with a preferred embodiment of the present invention. Low pressure, home soda machine 20 may comprise gas canister 12, a low pressure carbonation head 22, a bottle 24, a carbonation tube 13, a low pressure safety valve 26, and a low pressure exhaust valve 28. Low pressure carbonation head 22 may be similar in structure to carbonation head 10 and/or may have somewhat different elements which may be designed to operate with lower pressures.

Low pressure carbonation head 22 may receive pressurized CO₂, at a high pressure, such as 45 to 80 bar, from canister 12 and may provide the CO₂, via tube 13, to bottle 24. After carbonation and release of the extra accumulated gas, a consumer may remove bottle 24 from low pressure carbonation machine 20. Low pressure exhaust valve 26 may be similar in structure to exhaust valve 16 but may have a lower release point, thereby to define a lower operating pressure for home soda machine 20. For example, low pressure exhaust valve 26 may release gas at 5 bar instead of at 8 bar. In an alternative embodiment, low pressure exhaust valve 26 may release gas at 3 bar or lower. It will be appreciated that the release parameters of low pressure exhaust valve 26 may be determined by adjusting the tension of the spring standard to pressure exhaust valves.

Low pressure safety valve 28 may be similar in structure to safety valve 18 but may have a lower release point. For the 5 bar example above, low pressure safety valve 28 may release gas at 7.5 bar instead of at 11 bar. For the 3 bar example above, low pressure safety valve 28 may release gas at 5 bar.

Bottle 24 may have a lower yield point than that of bottle 14. In this embodiment, the lower yield point may be set to maintain the present safety margin between working pressure and yield point. Alternatively, bottle 24 may have a yield point similar to that of bottle 14, which will increase the safety margin of the bottle. Both embodiments provide improved safety over bottle 14 since, as mentioned hereinabove, the energy of explosion is significantly lower when the working pressure of the machine is lower than 8 bar and thus, there may be less damage when bottle 24 explodes.

Moreover, bottle 24 may have a longer lifetime since the pressure changes of the bottle, from its pressurized state to its non-pressurized state, are less dramatic with the lower pressure.

It will be appreciated that at low pressure, home soda machine 20 may operate at the lower pressure defined by the release pressure of low pressure exhaust valve 26. The consumer may pulse low pressure carbonation head 22 multiple times in order to carbonate the liquid. Each time, carbonation head 22 may transfer a small mass of gas from gas canister 12, into the liquid, labeled 30, via tube 13, which may have a small orifice. The high velocity of the mass of gas, caused by pushing the gas through the small orifice, may cause turbulence, labeled 32, in the water as the gas passes through the water and rises to the top of the bottle. The gas above the water may be a “cushion” 34 sitting on top of liquid 30 in bottle 24. Valve 26 may define the maximum pressure of cushion 34.

Applicant has realized that turbulence 32 may be sufficient by itself to carbonate liquid 30 to desired carbonation levels, such as of 3.5 g/l to 12 g/l. However, Applicant has also realized that cushion 34 may be needed to keep liquid 30 from being drawn up through the exhaust path of the machine along with the gas. Cushion 34 may also help to carbonate liquid 30.

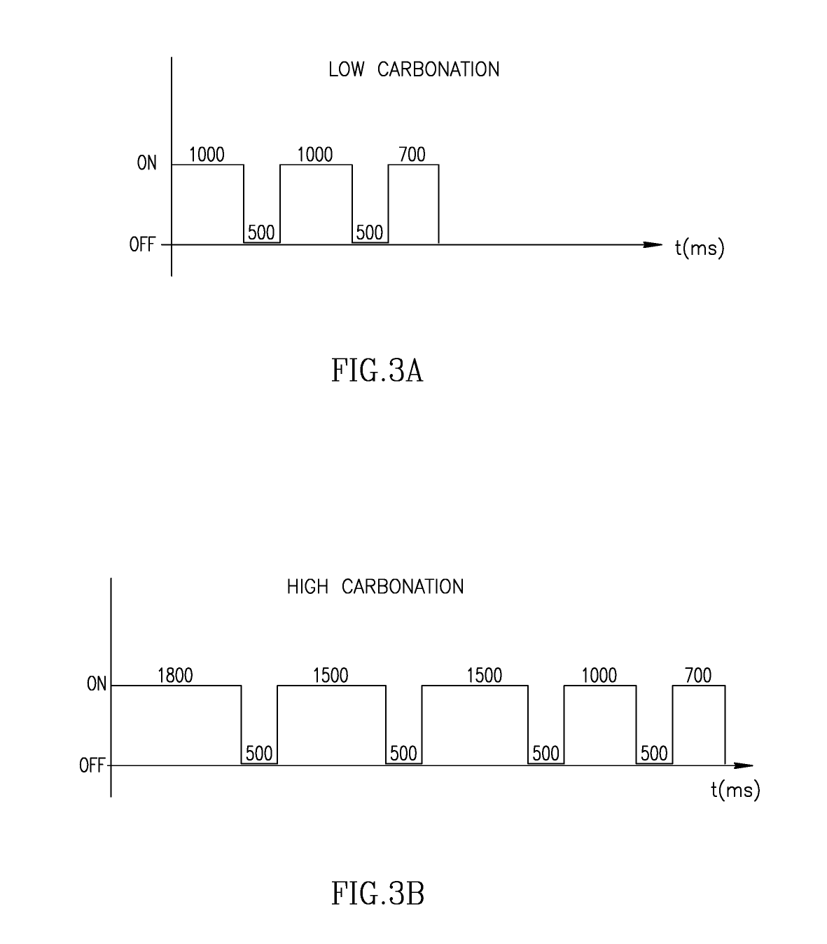

Reference is now made to FIGS. 3A and 3B, which are timing diagrams for automated carbonation pulses, useful in low pressure, home soda machine 20. To stop the liquid from being drawn up through the exhaust path of the machine along with the gas, machine 20 may modulate the carbonation pulses, in a manner similar to “pulse width modulation”. For a low level of carbonation, shown in FIG. 3A, there may be 3 pulses, each of a different length, where, for example, the pulses may be of 1000 ms, 1000 ms and 700 ms, respectively, with a fixed amount of time between pulses. For a higher level of carbonation, there may be more pulses. For example, they may be of 1800, 1500, 1500, 1000, 700 ms, respectively, with a fixed amount of time between pulses. In general, the pulses may increase in width and then decrease in width and there may be an additional short period of time before the machine may release the bottle. In addition, if desired, the time between pulses may vary.

Low pressure, home soda machine 20 may also be hand-operated. This embodiment may include a mechanism to slow down the release of the bottle after the user has performed the last pulse, in order to enable a full release of cushion 34 and to keep the liquid from squirting into the machine. For example, the mechanism may include a damper or a spring, such as is described US Patent Publication US 2015/0367296, published 24 Dec. 2015 and assigned to the common assignee of the present invention. It will be appreciated that at low pressure, soda machine 20 may provide high levels of carbonation with a pressurized CO₂ canister, but at low operating pressures. In fact, the present invention may utilize the lowest carbonation pressure that produces carbonation above 3.5 g/l but keeps the liquid from flowing up into carbonation head 22 with released CO₂ gas.

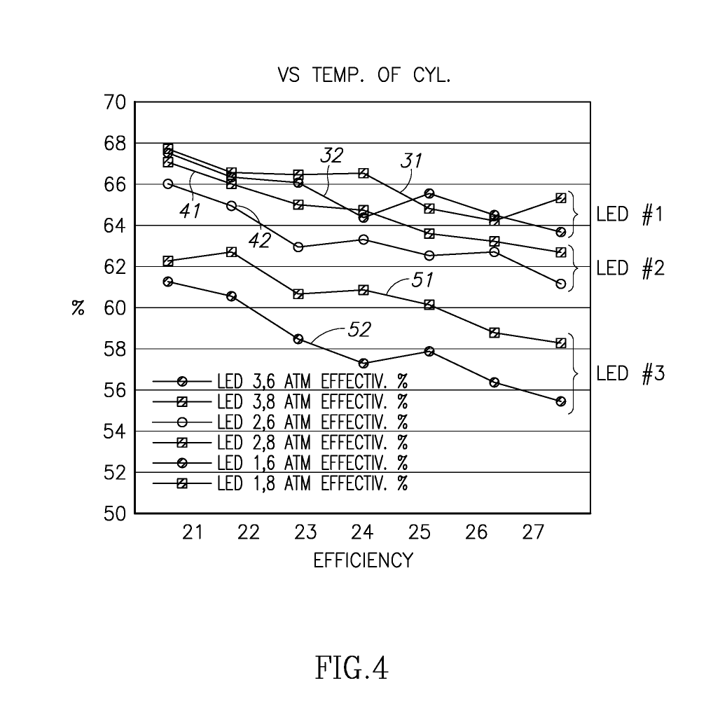

It will also be appreciated that, with the lower operating pressures, the CO₂ may be absorbed more efficiently into the liquid. Reference is now made to FIG. 4, which graphs the efficiency of the absorption of CO₂ as a function of temperature for a number of bottles, where efficiency is defined as the relationship between the amount of CO₂ absorbed in the water versus the amount of CO₂ released from the cylinder. As can be seen, the efficiency doesn't change much over temperature (it drops by only 2-4% over a change of 6° C.). Moreover, the curves are similar for the bottles with 6 bar exhaust valves (marked by circles) and with 8 bar exhaust valves (marked by squares). For example, curves 31 and 32 are for the same bottle carbonated with machines with 6 bar and 8 bar exhaust valves, respectively. Curves 31 and 32 are very similar, as are curves 41 and 42 (for a second bottle), and 51 and 52 (for a third bottle). Thus, the carbonation level does not significantly change as a function of the exhaust pressure of the machines.

Moreover, the efficiency increases with lower pressure. Note that curves 31, 41 and 51, at 6 bar, are generally above curves 32, 42 and 52, at 8 bar, indicating a higher efficiency at the lower operating pressure.

It will further be appreciated that, since the operating pressure of low pressure, soda machine 20 may be 6 bar or lower, the yield point of bottle 24 may be lower and therefore it may have significantly thinner walls than prior art bottle 14. Applicant has realized that, as a result, bottle 24 may be formed of glass or plastic. With lower pressure, not only is that less likely to explode, but the energy of the explosion is so much lower, that a person is less likely to get hurt from the exploding bottle.

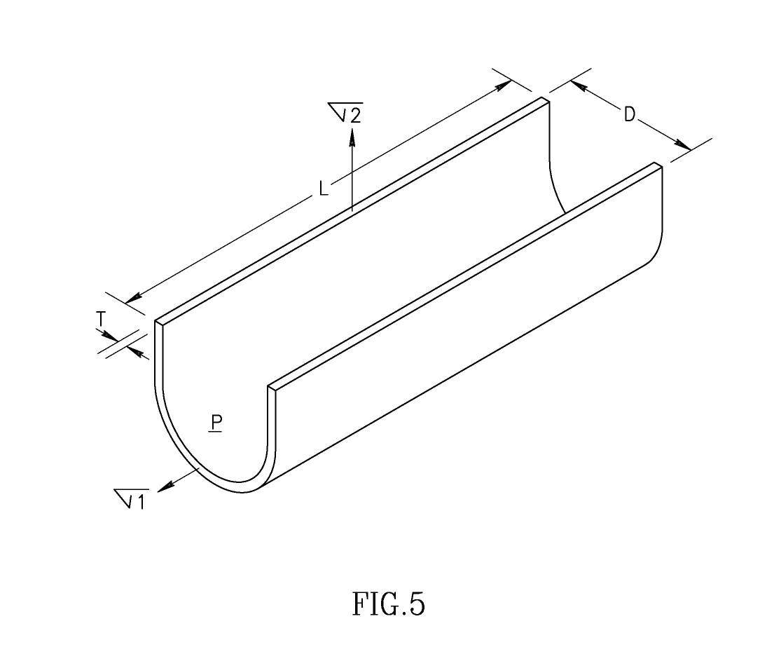

As shown in FIG. 5, to which reference is now made, there are two types of stresses in a thin walled pressure vessel containing a pressure P, a longitudinal stress σ₁ and a circumferential, hoop stress σ₂, defined as:

$${σ}_{1} = \frac{{F}_{1}}{{A}_{1}} = \frac{P π {R}^{2}}{2 π Rt} = \frac{PR}{2 t} = \frac{Pd}{4 t}$$

$${σ}_{2} = \frac{{F}_{2}}{{A}_{2}} = \frac{PdL}{2 tL} = \frac{Pd}{2 t}$$

The hoop stresses σ₂ in a 0.5 mm bottle, with a 8.4 cm diameter, at 6 and 8 bar are:

σ_{8bar}=8*8.4/2*0.05=672 atm≈67 MPa

σ_{6bar}=6*8.4/2*0.05=504 atm≈50 MPa

In addition, there are fluctuating stresses caused by changes in pressure, temperature, etc. to which the bottle may be exposed. The bottle has to be designed to withstand hoop stresses and fluctuating stresses so that it may operate for a significant length of time.

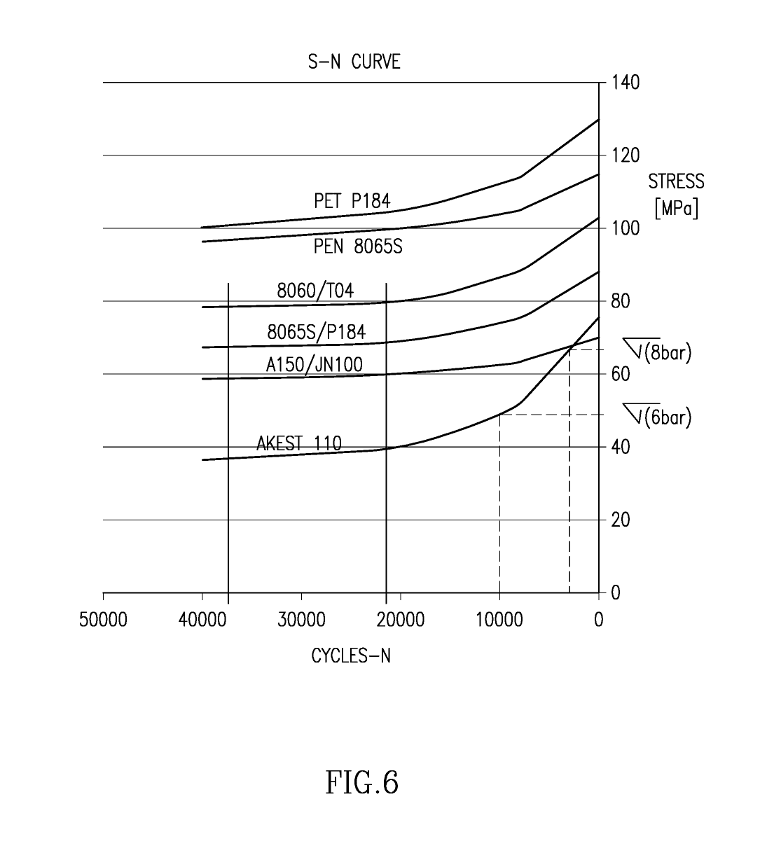

FIG. 6, to which reference is now briefly made, is a plot of stress S versus cycles N for 5 different types of plastics. At 0 cycles (on the right of the graph), the maximum hoop stress that the plastics can handle is relatively high, ranging from 75 MPa to 130 MPa. However, over multiple cycles, this range is reduced, such that, after 20,000 cycles, the range is 40 MPa to 100 MPa. After 20,000 cycles, the range doesn't change very much.

FIG. 6 also graphs the maximum hoop stresses at 6 and 8 bar, respectively, of 67 MPa and 50 MPa. As can be seen, the 8 bar point is fully below 4 of the curves but it hits the lower 2 curves at about 3,000 cycles. Thus, bottles operating at 8 bar cannot reasonably be made with the A150 or AKEST types of plastics of the lower 2 curves.

On the other hand, the 6 bar point is fully below 5 of the curves and it hits the lowest curve, the AKEST curve, at about 10,000 cycles, a significant improvement over the 8 bar point.

In addition to improving the useful life of bottle 24, reducing the operating pressure of the carbonation machine may also reduce the energy of explosion when bottle 24 bursts, an important safety issue.

In a gas, the stored energy U is:

$$U = \frac{PV}{γ - 1} [ 1 - {\{ \frac{{P}_{a}}{Pb} \}}^{\frac{γ - 1}{γ}} ]$$

Where P is the pressure in the bottle (8 bar or 6 bar), V is the volume of gas above the water line (head space), Pₐ is the initial pressure, P_{b} is the final pressure and γ is the adiabatic index which is 1.27 for CO₂. The smaller the volume and pressure, the smaller the potential energy (U) and the higher the volume and pressure, the higher the potential energy (U). The following table lists the explosion energy in Joules for different initial volumes at different pressures.

| | |
|---|---|
| Energy (Joules) | Pressure (bar) |

| Volume (cc) | 5 | 6 | 8 | 10 |
|---|---|---|---|---|
| 1000 | 536 | 704 | 1058 | 1433 |
| 150 | 80 | 105 | 159 | 215 |

As can be seen, the energy at 8 bar for 150 cc is about 50% more than the energy at 6 bar. The energy of 10 bar for 150 cc is roughly twice the energy at 6 bar.

Thus the working yield point of bottle 24 may be reduced in relation to the working pressure. It will be appreciated that as a result of this reduction, the margin between the yield point of bottle 24 and the working pressure of home carbonation machine 20 may be increased. For example, in a scenario using a typical home carbonation system of the prior art, the working pressure is 8 bar with the yield point of the bottle set to 17 bar and the margin is 2.125 times. (17:8). For the same bottle 24 in use with home carbonation machine 20, with the working pressure set to 5 bar the margin is raised to 3.4 times (17:5).

Thus, the reduced operating pressure of low pressure, home carbonation machine 20 produces a much safer operating environment. This is true for the bottle, which is less likely to explode and, even if it does, the effect is significant less dangerous, and for the machine, which provides the same level of carbonation. The manufacturing processes for low pressure machine 20 may be similar to that of the higher pressure machine 10 but the machine and bottle may be much safer and much less expensive to produce, since the materials need to withstand much lower pressures.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A home soda machine to carbonate a liquid within a removable bottle at an operating pressure within said bottle at or below 6 bar to a carbonation level of at least 3.5 g/l.

2. The home soda machine according to claim 1 and comprising:
a carbonation unit to receive pulsed carbon dioxide (CO₂) gas at at least 50 bar to provide said CO₂ gas turbulently within a liquid within said removable soda bottle; and
an exhaust valve to control an operating pressure of said machine to a maximum of 6 bar.

3. The home soda machine according to claim 2 and also comprising:
a carbonation tube to provide said pulsed CO₂ gas under a surface of said liquid.

4. The home soda machine according to claim 2 and wherein said exhaust valve is set to a pressure level retaining a cushion of CO2 gas above said liquid which keeps said liquid from flowing up into said carbonation head with released CO₂2 gas.

5. The home soda machine according to claim 2 and wherein said exhaust valve is set to 6 bar.

6. The home soda machine of claim 1 and wherein the yield point of said removable bottle is less than 16 bar.

7. The home soda machine of claim 6 and wherein said bottle is manufactured from at least one of: glass and plastic.

8. A method for a home soda machine comprising:
using turbulence to mix CO₂ gas under a surface of a liquid in a removable home soda bottle, said turbulence caused by CO₂ gas of at least 50 bar moving through a small orifice; and
controlling an operating pressure of said machine to a maximum of 6 bar.

9. The method according to claim 8 and also comprising providing said CO₂ gas via a carbonation tube.

10. The method according to claim 8 and wherein said controlling comprises modulating carbonation pulses of said CO₂ gas into said liquid to prevent said liquid from flowing up into said carbonation head with released CO₂ gas.

11. The method according to claim 8 and wherein said operating pressure is set to 6 bar.
